(19) United States
(12) Patent Application Publication
(10) Pub. No.: US 2023/0313923 A1
(43) Pub. Date: Oct. 5, 2023

(54) BAND CLAMP WITH RIB ON ITS INNER SURFACE

(71) Applicant: Oetiker Schweiz AG, Horgen (CH)

(72) Inventors: Markus WIDRIG, Horgen (CH); Maxime BÖSIGER, Horgen (CH); Tim WERNER, Horgen (CH); Melanie MÜLLER, Horgen (CH); Matthias KNÜSEL, Horgen (CH)

(73) Assignee: Oetiker Schweiz AG, Horgen (CH)

(21) Appl. No.: 17/861,894

(22) Filed: Jul. 11, 2022

(30) Foreign Application Priority Data
Apr. 4, 2022 (DE) 10 2022 108 054.4

(51) Int. Cl. F16L 21/06

(52) U.S. Cl. CPC F16L 21/06

(57) ABSTRACT

The invention relates to a band clamp (10) for connecting a cross-linked polyethylene (PEX) tubing (14) and a metal or plastic insert fitting (16), the band clamp (10) including a clamping band (18) including an ear-like tightening structure (12) and a closing structure (20) for connecting overlapping portions of the clamping band (18).

It is proposed that the inner contact surface (18a) of the clamping band (18) is configured to abut to the outer surface of the tubing (14) is provided with circumferential ribs (26, 28) protruding radially inward

The invention relates to a band clamp according to the preamble of claim 1 and to a connection system including such a band clamp.

ASTM Standard F 2098 specifies a connection between cross-linked polyethylene (PEX) tubing and a metal insert and plastic insert fittings. The fitting is inserted into the tubing, and a steel clamp clamped onto the tubing. The clamp is formed from a strip of stainless steel material having a mechanical interlock which maintains a circular configuration of the strip by attaching overlapping portions of the strip. To close the clamp, an ear-like raised outer portion of the strip acting as a tightening device is crimped together. The fitting includes circumferential annular ribs protruding radially and material of the tubing is pressed between the clamp and the annular ribs when the clamp is tightened. The axial position of the clamp above the annular ribs is essential for a reliable connection and is ensured by maintaining a distance of a few mm to the end of the tubing and to a flange of the fitting.

The document WO/2015/022024 discloses a clamp of the generic type for use with PEX tubing elements, the clamp comprising a clamping device in the form of a so-called Oetiker ear.

The document WO/2020/169222 a hose clamp consisting of a clamping strip having strip sections overlapping in the closed state of the hose clamp, on which hooks being made to protrude from the clamping strip via strain hardening and have a respective lobe. In the closed state of the hose clamp, the lobe of a hook arranged on the inner strip section and the lobe of a hook (arranged on the outer strip section overlap one another. In sections of the band including the hooks, a reinforcement rib is provided to compensate the weakening of the band due to the stamped-out hooks.

The document US 2006082156 A1 discloses a clamp for connecting a PEX tubing to a fitting with ribs. The clamp is provided with a liner sleeve positioned within the clamp ring. The liner sleeve includes a shoulder engaging the end of the tubing to appropriately position the clamp relative to the end of the tubing and, as a consequence, relative to the ribs of the fitting.

The invention is based on the problem of improving the sealing performance and reinforce the band material of a band clamp for connecting a cross-linked polyethylene (PEX) tubing and a metal or plastic insert fitting with annular ribs. A further object of the invention is to provide a sustainable band clamp with a desired sealing performance with low material consumption.

The problem is solved by a device having the features of claim 1. Advantageous embodiments of the invention are defined in the dependent claims.

The invention relates to Band clamp for connecting a cross-linked polyethylene (PEX) tubing and a metal or plastic insert fitting, the band clamp including a clamping band including an ear-like tightening structure and a closing structure of attaching overlapping portions of the strip.

It is proposed that the inner contact surface of the clamping band is configured to abut to the outer surface of the tubing is provided with circumferential ribs protruding radially inward. The provision of ribs both on the inner and outer surface of the tubing has been found to improve the performance of the clamps, i.e. the thermal cycle test prescribed in ASTM Standard F 877 and F 2098 can be successfully passed even when lower clamping forces are applied. For a given performance, the clamp according to the invention can be produced with thinner or narrower metal band than clamps according to the prior art.

In a preferred embodiment of the invention, the circumferential ribs extend over at least 80%, more preferably at least 90% of the length of the inner contact surface. The inner contact surface is defined as those parts of the inner surface of the clamping band which are designed to come in contact with the tubing, i.e. excluding the ear-like tightening structure or the outer band portions overlapping with inner band portions at the closing structure.

Preferably, the circumferential ribs are provided at the lateral edges of clamping band, i.e. less than 1-2 mm from the lateral edge of the band, wherein the precise distance may be set dependent on the width.

In a preferred embodiment of the invention, the ribs are created by a cold forming process, in particular embossing, so as to achieve additional hardening of the material, which entails further improvements in the performance. Preferably, the ridges or ribs on the inside is the result of a corresponding notches or dimples embossed on the outside of the band. This ensures a sustainable and material-saving manufacturing process with proven and tested means.

Preferably, the distance between at least two of the circumferential ribs essentially equal to the distance between annular ribs of the insert fitting, wherein “essentially equal” in this context means that differences of the order of magnitude of the tolerances are allowed. This improves the sealing performance if the ribs are aligned because the peaks in the force distribution resulting from both kinds of ribs may be superimposed. However, even if the alignment is not perfect, the performance of the clamp is improved by the ribs of the clamps because of an inter-meshing-effect of the ribs. Preferably, the distance between at least two of the circumferential ribs is in a range between 0.9 times and 1.1 times the distance between the annular ribs of the insert fitting according to the relevant standard.

A further aspect of the invention relates to a connector system for connecting a cross-linked polyethylene (PEX) tubing and a metal or plastic insert fitting, the system including a and clamp according to one of the preceding claims.

It is proposed that the distance between at least two of the circumferential ribs of the inner contact surface of the clamping band is at least 1.2 times larger than the distance between axially outer edges of annular ribs of the insert fitting.

Further features and advantages will be apparent from the following description of the embodiments and figures. The entire description, claims and figures disclose features of the invention in specific embodiments and combinations. The person skilled in the art will also consider the features individually and combine them into further combinations or sub-combinations to adapt the invention, as defined in the claims, to his needs or to specific fields of application.

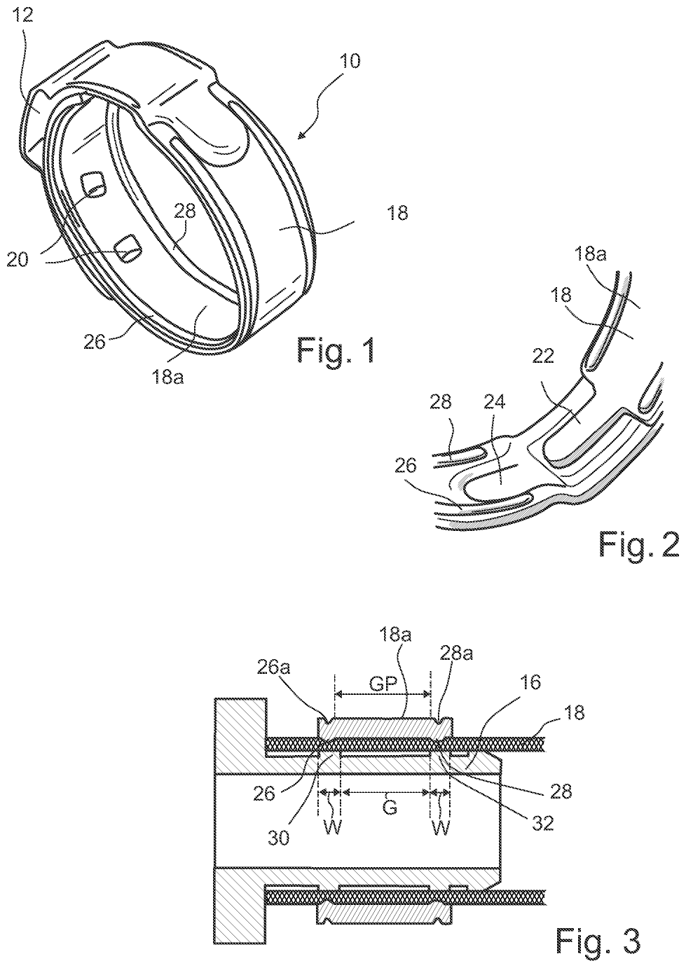

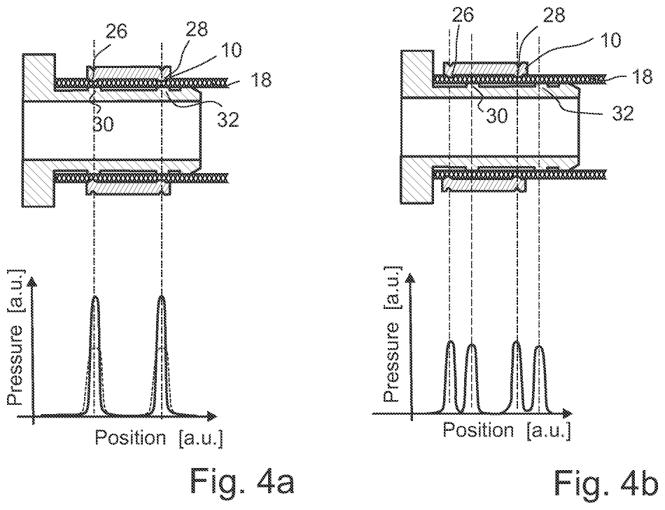

The figures illustrate the following:
FIG. 1 according to a first embodiment of the invention;
FIG. 2 a detailed view of a tongue and a recess of the clamp according to FIG. 1;
FIG. 3 a sectional view of a system including a band clamp according to the invention and an insert fitting;
FIG. 4a illustrates the force distribution generated by an ideally mounted band clamp according to the invention; and
FIG. 4b illustrates the force distribution generated by band clamp according to the invention mounted at a displaced position.

FIG. 1 shows a band clamp 10 according to first embodiment of the invention. The band clamp comprises a tightening structure 12 in the form of a so-called Oetiker ear. The tightening structure 12 includes two radially outward extending legs and a web interconnecting the outer ends of the legs. A depression is stamped in the web of the tightening device to prevent buckling. In the mounted configuration of FIG. 3, band clamp 10 surrounds a PEX tubing 14 at a position where a PEX insert fitting 16 in compliance with ASTM Standard F 2098 is inserted into the tubing 14.

The band clamp 10 further comprises a closing structure for connecting overlapping portions of the clamping band 18. The clamping band 18 includes an inner end portion which is overlapped by and outer end portion. The closing structure 20 is formed by one or more hooks at the inner end portion and openings at the outer end portion, wherein the hooks are configured to engage with the openings in use.

On the side opposite to the closing structure 20 in relation to the tightening structure 12, the inner end portion is provided with a tongue 22 and the outer band portion is provided with a recess 24 for receiving the tongue 22 when the tightening structure 12 is being closed, i.e. when the legs of the tightening structure 12 are pressed against each other to reduce the diameter of the band clamp 10.

In order to make the installation of the clamp 10 on a tubing 14 (FIG. 3) easier, the clamp 10 is pre-deformed beforehand, for example in the course of production. Ideally this deformation is such that, prior to tightening the tightening structure 12, the band clamp 10 surrounds the tubing 14 for which the clamp 10 is intended without play. Because of the elasticity produced in the clamp 10 by this pre-deformation, the clamp 10 still can be moved effortlessly to the installation location on the pipe and yet is retained there in the position of the clamp 10 and in the desired orientation. However, in real life, the tolerance range of the fitting a 16 and the tubing 18 are so large that the clamp 10 is sometimes difficult to be brought into the correct position with the maximum outer diameter of the fitting 16 and tubing 18, whereas clamp may not hold on the tubing 18 if the diameter of the tubing 18 is at the lower range of the tolerance range.

The diameter of the pre-assembled (i.e. closed but not tightened) configuration of the band clamp 10 is preferably adapted to the outer diameter corresponding to one of the standard diameters for PEX tubing 14s as defined in the following Table:

TABLE 1
Standard sizes for PEX tubes

| Nominal Tubing 14 | Outer | Minimum wall | Inner |
|---|---|---|---|
| size | Diameter | thickness | Diameter |
| 3/8″ | 0.500″ | 0.070″ | 0.360″ |
| 1/2″ | 0.625″ | 0.070″ | 0.485″ |
| 5/8″ | 0.750″ | 0.083″ | 0.584″ |
| 3/4″ | 0.875″ | 0.097″ | 0.681″ |
| 1″ | 1.125″ | 0.125″ | 0.875″ |

According to the invention, the inner contact surface 18a of the clamping band 18 is provided with circumferential, continuously formed ribs 26, 28 26, 28 at the lateral edges of clamping band 18, the ribs 26, 28 protruding radially inward. In this context, the inner contact surface 18a is defined as the surface designed to abut to the outer surface of the tubing 14.

As illustrated in FIG. 2, the circumferential ribs 26, 28 display a small gap at the shoulders delimiting the tongue 22 from the remainder of the clamping band 18. However, the circumferential ribs extend over at least 90% of the length of the inner contact surface 18a. In other embodiments of the invention, the circumferential ribs 26, 28 extend over at least 80% of the length of the inner contact surface 18a.

As illustrated in FIG. 3, the distance GP between at least two of the circumferential ribs 26, 28 preferably roughly the same than the distance between annular ribs 30, 32 of the insert fitting 16, wherein differences in the order of magnitude of the tolerances are, of course, unavoidable. The ridges or ribs 26, 28 on the inside are the result of a corresponding notches 26a, 28a or dimples (FIG. 3) embossed on the outside of the band, wherein the notches 26a, 28a are made with the distance and dimensions as specified.

The Gap GP between the outermost ribs 26, 28 as illustrated in FIG. 3 is preferably in compliance with the formula

0.9*GP≤G≤1*GP

wherein G is the gap between the ribs 30, 32 of the fitting 16 as defined in the ATSM standard F2159 for plastic fittings or F1807 for metal fittings. Specifically, the recommended range for G is 0.12″-0.145″ (3.05-3.68 mm) for nominal sizes ⅜″, ½″, ⅝″, ¾″, 1″, 1¼″ and 0.12″-0.18″ (3.05-4.57 mm) for nominal sizes 1½″ and 2″ for metal fittings 16 and G is 0.135″-1.52″ (3.43-3.86 mm) for plastic fittings 16 of any nominal size.

The inventors have found that the width W of the band is preferably increased over the value of the ASTM Standard F 2098, specifically that the clamps with nominal diameters ⅜″, ½″, ⅝″ (20.8 mm, 23.3 mm or 29.6 mm) preferably have a width W of 9 mm or more instead of 7 mm as prescribed in the ASTM Standard F 2098.

The inventors have experimentally verified that clamp 10 according to the invention passes the thermal cycle test according to ASTM Standard F 2098 even when lower clamping forces than in conventional clamps are applied.

The reason for this improved sealing performance is that the pressure exerted by the clamp concentrates in narrower ranges because the ribs 26, 28 of the band clamp 10 and the ribs 30, 32 of the fitting 16 act from both sides of the tubing 18. Each of the ribs 26, 28, 30, 32 generates a peak of the force in the axial force distribution as illustrated in FIG. 4a and in FIG. 4b.

FIG. 4a illustrates the force distribution generated by an ideally mounted band clamp according to the invention in which the ribs 26, 28 of the band clamp 10 are aligned with the ribs 30, 32 of the fitting 16 such that the force peaks are superimposed. The resulting peaks (solid line) in the surface pressure distribution is narrower than the corresponding peak generated by a conventional clamp tightened with the same clamping force, which is indicated as a dashed line in FIG. 4a.

FIG. 4b illustrates the force distribution generated by band clamp according to the invention mounted at a displaced position. In the configuration of FIG. 4a, the ribs 26, 28 of the band clamp 10 are not aligned with the ribs 30, 32 of the fitting 16 such that the resulting peaks are not superimposed. However, the inventors have found that the performance of the clamp is improved by the ribs 26, 28 nonetheless due to the une-venness in the force distribution and the intermeshing arrangement of the ribs 26, 28 and the ribs 30, 32, even in the worst case scenario.

It is to be noted that, in real-life scenarios, the tolerances of the gap G and the width W of the ribs 30, 32 of the fitting 16 are quite large such that a perfect alignment is rarely ever achievable. However, even in scenarios where the gaps G and GW do not match, the sealing performance can be improved by the effect of the additional force peaks as illustrated in FIG. 4b. Depending on the circumstances, it is possible that one pair of ribs 26, 30 or 28, 32 is aligned as in FIG. 4a and the other pair of ribs is displaced as in FIG. 4b. Again, the sealing-and clamping-performance is improved even in the worst-case scenario.

In further embodiments of the invention, a third rib may be provided on the inner surface of the band clamp 10 so as to be located in the gap G between the ribs 30, 32 of the fitting 16 in the mounted configuration.

### List of Reference Numbers

10 band clamp
12 tightening structure
14 PEX tubing
16 insert fitting
18 clamping band
20 closing structure
22 tongue
24 recess
26 rib
28 rib
30 rib
32 rib

1. A band clamp (10) for connecting a cross-linked polyethylene (PEX) tubing (14) and a metal or plastic insert fitting (16), the band clamp (10) including a clamping band (18) including an ear-like tightening structure (12) and a closing structure (20) for connecting overlapping portions of the clamping band (18), wherein the inner contact surface (18a) of the clamping band (18) is configured to abut to the outer surface of the tubing (14) is provided with circumferential ribs (26, 28) protruding radially inward.

2. A band clamp (10) according to claim 1, wherein the circumferential ribs (26, 28) extend over at least 90% of the length of the inner contact surface (18a).

3. A band clamp (10) according to claim 1 wherein the circumferential ribs (26, 28) are provided at the lateral edges of clamping band (18).

4. A band clamp (10) according to claim 1 wherein the distance (GP) between at least two of the circumferential ribs (26, 28) essentially equal to the distance between annular ribs (30, 32) of the insert fitting (16).

5. A band clamp (10) according to claim 1 wherein the distance (GP) between at least two of the circumferential ribs (26, 28) is within a range between 0.9 times and 1.1 times the distance (G) between axially outer edges of annular ribs (30, 32) of the insert fitting (16).

6. A connector system for connecting a cross-linked polyethylene (PEX) tubing (14) and a metal or plastic insert fitting (16), the connector system including a band clamp (10) according to claim 1 wherein the distance between at least two of the circumferential ribs (26, 28) of the inner contact surface (18a) of the clamping band (18) is approximately equal to the distance between axially outer edges of annular ribs (26, 28) of the insert fitting (16).
